(19) United States
(12) Patent Application Publication
(10) Pub. No.: US 2010/0304142 A1
(43) Pub. Date: Dec. 2, 2010

(54) COLOR ERASABLE RECORDING MATERIAL AND METHOD FOR PRODUCING THE SAME

(75) Inventors: Tsuyoshi Itou, Shizuoka-ken (JP); Takayasu Aoki, Shizuoka-ken (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/784,909

(22) Filed: May 21, 2010

Related U.S. Application Data
(60) Provisional application No. 61/181,419, filed on May 27, 2009.

(51) Int. Cl. C09D 5/00

(52) U.S. Cl. 428/402; 106/31.01; 106/31.13; 524/599

(57) ABSTRACT

According to one embodiment, a method for producing a color erasable recording material includes dispersing a granulated mixture of a color erasable recording material in an aqueous medium to form an aqueous dispersion liquid, and subjecting the dispersion liquid to a high-pressure pulverizer at a temperature not lower than the melting point of a color erasing agent to pulverize the granulated mixture in the dispersion liquid, thereby obtaining a particulate color erasable recording material having a volume average particle diameter smaller than that of the granulated mixture.

### CROSS-REFERENCE TO RELATED APPLICATIONS

This application is based upon and claims the benefit of priority from U.S. Provisional Application No. 61/181,419, filed May 27, 2009, the entire contents of which are incorporated herein by reference.

### FIELD

Embodiments described herein relate generally to a recording material such as a developing agent to be used in an electrophotographic process, an electrostatic printing process, a magnetic recording process, or the like, or an ink to be used in inkjet printing or the like; and a method for producing the same.

### BACKGROUND

A method of recycling a recording medium such as paper by erasing an image formed on the recording medium using a color erasable recording material such as a developing agent or an inkjet ink is very effective from the viewpoint of environmental protection and economic efficiency due to reduction in the using amount of a recording medium such as paper. For example, a color erasable toner can be produced by incorporating a color developable compound and a color developing agent in the inside of a toner using a kneading pulverization method. By heating paper on which an image was printed using this toner at a temperature between 100° C. and 200° C. for about 1 to 3 hours, the color of the recording material in the printed region can be erased. Further, by erasing the color of the recording material, the paper on which the image in the printed region was erased can be recycled. With the use of a color erasable recording material as this toner, the consumption of paper can be reduced, and therefore, it is an excellent technique capable of contributing to a decrease in the environmental load.

However, when the kneading pulverization method is used, kneading is performed at a high temperature between about 100° C. and 200° C. while applying a high shearing force, and therefore, the color developable compound and the color developing agent are uniformly dispersed in a binder resin, and therefore, the developed color density of the toner is decreased. Further, when a toner material such as a binder resin or a release agent has a color erasing action, the developed color density of the toner is decreased at the time of kneading, similarly. Therefore, it is necessary to select a material having a low color erasing action as a material to be used for a color erasable toner such as a binder resin. In particular, as the binder resin, only a specific resin such as a styrene-butadiene resin can be used, and there is a problem that it is very difficult to use a polyester resin having excellent fixability.

In view of the above problems, a wet-type production method for obtaining a toner by aggregating and fusing color erasable color-forming fine particles and fine particles of a binder resin or the like in an aqueous medium is being studied. Such color erasable color-forming fine particles contain a color developable compound and a color developing agent and have a particle diameter of, for example, several micrometers. According to this method, since a toner is produced by aggregating fine particles, the particle diameter can be reduced, and the shape can be changed from a potato-like shape to a spherical shape depending on the conditions for a heating treatment to effect fusion. Further, it is possible to allow the color erasable fine particles to mix and coalesce with the binder resin or the like without undergoing mechanical shearing or high heat history by melt-kneading. For example, a toner can be formed at a low temperature lower than 80° C. as long as the temperature exceeds Tg of the binder resin. Therefore, it is a very effective production method for a toner which comprises an encapsulated color erasable recording material or a toner which is irreversibly erased by heat history.

On the other hand, there is an inkjet process as an image forming method other than an electrophotographic process. The inkjet process has a problem of paper curling when continuous printing on plain paper is performed, and so on, however, the process has a characteristic that it does not involved in heat history with respect to a recording material such as a fixing step in the electrophotographic process. Therefore, the inkjet process is very effective process for a material to be erased by heating.

However, as described above, currently, there is a problem that only color erasable recording material having a large particle diameter of about several micrometers can be produced, and when the material is applied to a toner by an aggregation method, there is a problem that only a toner having a large particle diameter of from 10 to 15 μm can be produced. Further, since the particle diameter of the color-forming fine particles is large, there is a problem that it is difficult to incorporate the fine particles in the inside of a toner.

On the other hand, when such color-forming fine particles are applied to an inkjet ink, since an inkjet nozzle has a diameter of from about 10 to 30 μm, there is a problem that the nozzle is clogged, and therefore it is difficult to output an image. Further, since the color-forming fine particles precipitate, there is a problem that it is necessary to take measures to prevent precipitation.

In light of the above, color erasable color-forming fine particles having a particle diameter of submicron order are being demanded.

### BRIEF DESCRIPTION OF THE DRAWINGS

FIG. 1 is a flow diagram showing a method for producing a color erasable recording material according to one embodiment.

FIG. 2 is a schematic view showing a structure of a high-pressure pulverizer which can be used in one embodiment.

FIG. 3 is a flow diagram showing a modification example of the method shown in FIG. 1.

FIG. 4 is a model view showing a manner in which the color of fine particles of a color erasable recording material according to one embodiment is developed.

FIG. 5 is a model view showing a manner in which the color of fine particles of a color erasable recording material according to one embodiment is erased.

FIG. 6 is a flow diagram showing a method for producing a developing agent according to one embodiment.

FIG. 7 is a schematic view showing a structure of a copier to which a developing agent obtained according to one embodiment can be applied.

### DETAILED DESCRIPTION

One of the embodiments described herein is a method for producing a color erasable recording material containing a color developable compound, a color developing agent, and a color erasing agent having a melting point of from 40° C. to 200° C., comprising: preparing a granulated mixture containing a color developable compound, a color developing agent, and a color erasing agent having a melting point of from 40° C. to 200° C. and dispersing the resulting granulated mixture in an aqueous medium, thereby forming an aqueous dispersion liquid; and subjecting the resulting dispersion liquid to a high-pressure pulverizer at a temperature not lower than the melting point of the color erasing agent to pulverize the granulated mixture in the dispersion liquid, thereby obtaining a color erasable recording material in the form of fine particles having a volume average particle diameter smaller than that of the granulated mixture.

Further, another embodiment provides a color erasable recording material in the form of fine particles obtained by the above method for producing a color erasable recording material, more specifically, by dispersing a granulated mixture containing a color developable compound, a color developing agent, and a color erasing agent having a melting point of from 40° C. to 200° C. in an aqueous medium, thereby forming an aqueous dispersion liquid of the granulated mixture and subjecting the dispersion liquid to a high-pressure pulverizer at a temperature not lower than the melting point of the color erasing agent, thereby pulverizing the granulated mixture in the dispersion liquid into fine particles having a particle diameter smaller than that of the granulated mixture.

Still another embodiment is a method for producing a color erasable developing agent to which the above method is applied, comprising preparing a granulated mixture containing a color developable compound, a color developing agent, and a color erasing agent having a melting point of from 40° C. to 200° C. and dispersing the resulting granulated mixture in an aqueous medium, thereby forming an aqueous dispersion liquid; subjecting the resulting dispersion liquid to a high-pressure pulverizer at a temperature not lower than the melting point of the color erasing agent to pulverize the granulated mixture in the dispersion liquid, thereby obtaining a color erasable recording material in the form of fine particles having a volume average particle diameter smaller than that of the granulated mixture; preparing an aqueous dispersion liquid containing the color erasable recording material in the form of fine particles, a binder resin material in the form of particles, and an aqueous medium; and aggregating the recording material in the form of fine particles and the binder resin material in the form of particles in the dispersion liquid, thereby obtaining toner particles.

Still another embodiment provides a color erasable developing agent obtained by the above method for producing a developing agent and containing a color erasable recording material in the form of fine particles and a binder resin material, wherein the color erasable recording material in the form of fine particles is obtained by dispersing a granulated mixture containing a color developable compound, a color developing agent, and a color erasing agent having a melting point of from 40° C. to 200° C. in an aqueous medium, thereby forming an aqueous dispersion liquid of the granulated mixture, and subjecting the dispersion liquid to a high-pressure pulverizer at a temperature not lower than the melting point of the color erasing agent, thereby pulverizing the granulated mixture in the dispersion liquid into fine particles having a particle diameter smaller than that of the granulated mixture.

According to one embodiment, the color erasable recording material in the form of fine particles can have a volume average particle diameter of from 0.05 to 1 μm.

Hereinafter, embodiments will be described in more detail with reference to the drawings.

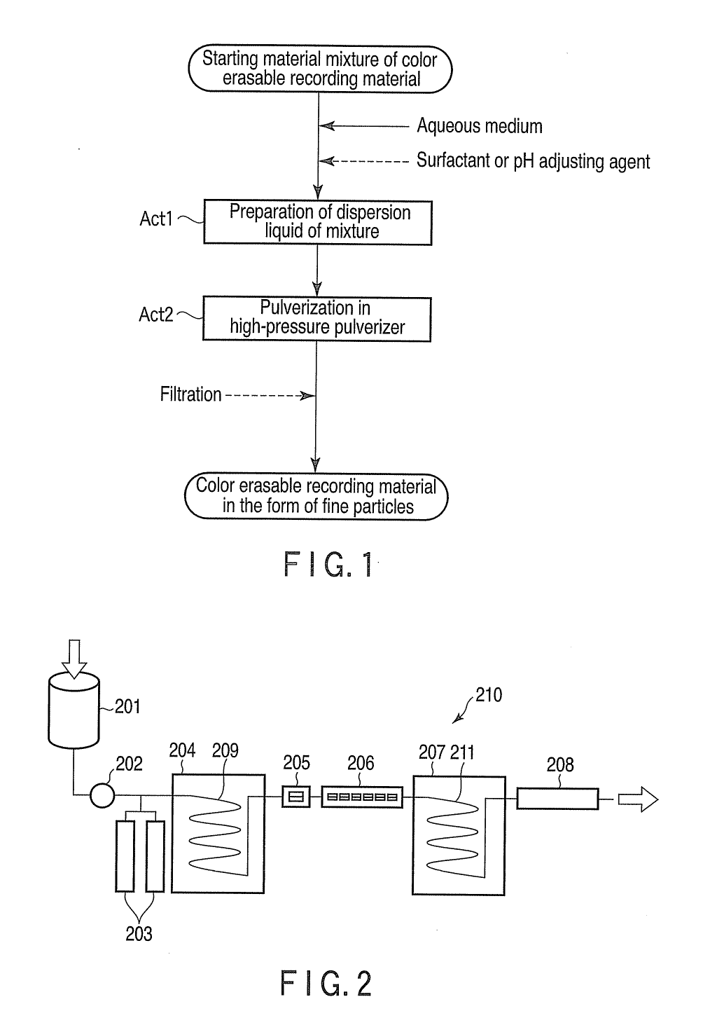

FIG. 1 is a flow diagram showing a method for producing a color erasable recording material according to one embodiment.

In a method for producing a color erasable recording material according to one embodiment, first, a granulated mixture containing a starting material mixture of a color erasable recording material containing a color developable compound, a color developing agent, and a color erasing agent having a melting point of from 40° C. to 200° C. is prepared.

The granulated mixture can be formed by, for example, melt-kneading the starting material mixture of a color erasable recording material at a temperature not lower than the melting point of the color erasing agent, followed by cooling, drying, and coarsely pulverizing the melt-kneaded material.

The coarsely pulverized particles can be obtained by a step of melt-kneading a mixture containing, for example, at least a color developable compound, a color developing agent, and a color erasing agent having a melting point of from 40° C. to 200° C., and then coarsely pulverizing the melt-kneaded material. The coarsely pulverized particles can have a volume average particle diameter of from 0.01 mm to 2 mm. When the volume average particle diameter thereof is less than 0.01 mm, strong stirring is required for dispersing the particles in an aqueous medium, and bubbles generated by the stirring tend to decrease dispersion of the mixture. Meanwhile, when the volume average particle diameter thereof exceeds 2 mm, because the particle diameter is larger than a gap provided in a shearing unit, the particles are caught in the shearing unit or a difference in the applied energy is generated between the inside and the outside of the mixture, therefore, particles having a non-uniform composition or a non-uniform particle diameter tend to be formed.

The coarsely pulverized particles can more preferably have a volume average particle diameter of from 0.02 mm to 1 mm.

Subsequently, the coarsely pulverized particles are dispersed in an aqueous medium to form a dispersion liquid of the coarsely pulverized particles (Act 1).

In the step of forming the dispersion liquid of the coarsely pulverized particles, at least one of a surfactant and an alkaline pH adjusting agent can be added to the aqueous medium.

By the addition of a surfactant, the coarsely pulverized particles can be easily dispersed in the aqueous medium due to the action of the surfactant adsorbed on the surfaces of the particles.

As the color erasing agent to be used for the color erasable recording material, a color erasing agent having low hydrophilicity is sometimes used. It is very difficult to disperse the coarsely pulverized particles containing a color erasing agent having low hydrophilicity in water without a surfactant. At this time, the concentration of the surfactant can be set to the critical micelle concentration thereof or higher. Here, the critical micelle concentration refers to the minimum concentration of a surfactant necessary for forming micelles in water and can be determined by measuring the surface tension or electrical conductivity. When the surfactant is contained at a critical micelle concentration or higher, the coarsely pulverized particles are more easily dispersed.

On the other hand, by the addition of an alkaline pH adjusting agent, the degree of dissociation of a dissociable functional group on the surface of the color erasing agent having a melting point of from 40° C. to 200° C. is increased or the polarity thereof is increased, and therefore, the self-dispersibility can be improved.

Subsequently, the thus obtained dispersion liquid is subjected to defoaming as needed. When the color erasing agent has low hydrophilicity, it can be dispersed in water using a surfactant, however, not a few bubbles are incorporated at the time of mixing. When a pulverization treatment of the post-step is performed using a high-pressure pulverizer in a state where such bubbles are incorporated in the mixture, the blank firing of the plunger of the high-pressure pump occurs and the movement of the plunger becomes unstable. In particular, when a plurality of plungers are mounted in a row for the purpose of eliminating a pulsating current, the movement of the plurality of plungers is controlled, and therefore, if blank firing occurs, the pulverization treatment cannot be performed in some cases. Further, the high-pressure pulverizer has a check valve, therefore, if bubbles are incorporated in the process liquid, the particles are liable to adhere to this check valve and the check valve is clogged. If the check valve is clogged, the process liquid does not flow and the pulverization treatment cannot be performed in some cases.

Examples of the defoaming method include defoaming under reduced pressure or in vacuo, defoaming by centrifugation, and addition of a defoaming agent. The defoaming method may be any as long as bubbles can be removed, however, in the case of adding a defoaming agent, it is necessary to select the agent which does not affect the post-treatment. Also, it is important that the agent does not remain in the resulting toner so as not to deteriorate the charging characteristic and the like. As a simple method, defoaming under reduced pressure can be exemplified. In this method, the process liquid is fed to a pressure-resistant vessel equipped with a stirrer, and the pressure in the vessel is reduced to around −0.09 MPa using a vacuum pump while stirring to effect defoaming.

After the dispersion liquid is formed, the dispersion liquid may be subjected to wet pulverization or heat emulsification as needed. By further reducing the particle diameter through pulverization or emulsification, the subsequent treatment may sometimes become stable.

Subsequently, the resulting dispersion liquid is subjected to mechanical shearing using a high-pressure pulverizer and the coarsely pulverized mixture is further pulverized to form fine particles of a color erasable recording material (Act 2).

FIG. 2 is a schematic view showing a structure of a high-pressure pulverizer which can be used in one embodiment.

The high-pressure pulverizer is a device configured so as to apply a shearing force by allowing a material to pass through a fine nozzle while applying a pressure of from 10 MPa to 300 MPa by means of a high-pressure pump to pulverize the material into fine particles.

As shown in FIG. 2, a high-pressure homogenizer 210 which is one example of the high-pressure wet-type pulverizer has a structure in which a hopper tank 201, a liquid feed pump 202, a high-pressure pump 203, a heating unit 204, a pulverizing unit 205, a pressure reducing unit 206, a cooling unit 207, and a pressure reducing unit 208 are arranged in this order, and includes pipes which connect the respective units.

The hopper tank 201 is a tank to which a process liquid is fed. While the device is being operated, it is necessary to always fill the tank with a liquid so as not to send air to the device. When the particles in the process liquid have a large particle diameter and are likely to precipitate, a stirrer can be further installed in the tank.

The liquid feed pump 202 is installed for continuously feeding the process liquid to the high-pressure pump 203. Further, this liquid feed pump 202 is also effective in avoiding clogging of a check valve (not shown) installed in the high-pressure pump 203. As the pump 202, for example, a diaphragm pump, a tubing pump, a gear pump, or the like can be used.

The high-pressure pump 203 is a plunger pump and has check valves at a process liquid inlet port (not shown) and a process liquid outlet port (not shown). The number of plungers varies depending on the production scale, and one to ten plungers are used. In order to reduce a pulsating current as much as possible, it is preferred that two or more plungers are used.

The heating unit 204 is provided with a high-pressure pipe 209 formed in a spiral shape so as to have a large heat exchange area in a heating device such as an oil bath. It does not matter whether this heating unit 204 is installed in the upstream side or downstream side of the high-pressure pump 203 in the flow direction of the dispersion liquid, however, it is necessary to install this heating unit 204 at least in the upstream side of the pulverizing unit 205. When the heating unit 204 is installed in the upstream side of the high-pressure pump 203, a heating device may be installed in the hopper tank 201, however, the time for which the process liquid is retained at a high temperature is long, and therefore, the color developable compound or the color developing agent in the process liquid is liable to be thermally decomposed.

The pulverizing unit 205 includes a nozzle having a small diameter for applying a strong shearing force. The diameter and shape of the nozzle vary, however, the diameter thereof is preferably from 0.05 mm to 0.5 mm, and as for the shape thereof, a pass-through type nozzle or a collision type nozzle is preferred. Further, this nozzle may be configured in a multiple-stage structure. When a multiple-stage structure is employed, a plurality of nozzles having different diameters may be arranged. As for the configuration of the arrangement of such nozzles, either series or parallel configuration may be employed. As the material of the nozzle, diamond or the like which can withstand a high pressure is used.

The cooling unit 207 is provided with a pipe 211 formed in a spiral shape so as to have a large heat exchange area in a bath in which cold water is allowed to continuously flow.

According to need, pressure reducing units 206 and 208 can be installed in the upstream and downstream of the cooling unit 207. The pressure reducing units 206 and 208 have a structure in which one or more cells or two-way valves having a flow path that is larger than the diameter of the nozzle of the pulverizing unit 205 and smaller than the diameter of the pipe connected thereto are arranged.

A treatment using this high-pressure pulverizer is performed as follows.

First, the process liquid is heated to a temperature not lower than the melting point of the color erasing agent to be used. The reason why the liquid is heated is to melt the color erasing agent to be used.

This heating temperature varies depending on the melting characteristics of the color erasing agent. When the color erasing agent is easy to melt, the heating temperature may be set to low, however, when the color erasing agent is difficult to melt, the heating temperature should be set to high. Further, in the case of using a method of heating the dispersion liquid by continuously passing it through the heat exchanger, the heating temperature is also affected by the flow rate of the dispersion liquid and the length of the pipe in the heat exchanger. When the flow rate is high or the length of the pipe is small, the heating temperature should be set to a high temperature, meanwhile, when the flow rate is low or the length of the pipe is large, the dispersion liquid is sufficiently heated, therefore, it is possible to perform the treatment at a low temperature. When the flow rate is from 300 to 400 cc/min, the heat exchange pipe is a high-pressure pipe having a diameter of ⅜ inch and a length of 12 m, and the melting point of the color erasing agent is 45° C., the heating temperature may be set to 50° C. to 100° C.

Then, the dispersion liquid thus heated is subjected to a shearing force while applying a pressure of 10 MPa or more. At this time, it is the nozzle that applies the shearing force. By allowing the dispersion liquid to pass through the nozzle while applying a high pressure of 10 MPa or more, the molten color erasing agent is pulverized into fine particles. The pressure at this time may be from 10 MPa to 300 MPa.

Finally, the dispersion liquid is cooled to a temperature not higher than the Tg of the color erasing agent. By this cooling, the molten fine particles are solidified. Since the process liquid is rapidly cooled, aggregation or coalescence due to cooling is difficult to occur.

According to need, a back-pressure may be applied to the upstream or downstream of the cooling unit or a pressure may be reduced. The back-pressure application or pressure reduction is performed for returning the pressure of the process liquid after passing through the nozzle to close to atmospheric pressure in a single step (by back-pressure application) or in multiple steps (by pressure reduction) so as not to release the process liquid to atmospheric pressure immediately after passing through the nozzle. The pressure after passing through a back-pressure applying unit or a pressure reducing unit is from 0.1 MPa to 10 MPa, preferably from 0.1 MPa to 5 MPa. It is more preferred that in this pressure reducing unit, a plurality of cells or valves with different diameters are arranged. By reducing the pressure in multiple steps, few coarse particles are generated and fine particles having a sharp particle size distribution can be obtained.

From the thus obtained fine particles, the dispersion medium can be removed by suction filtration as needed.

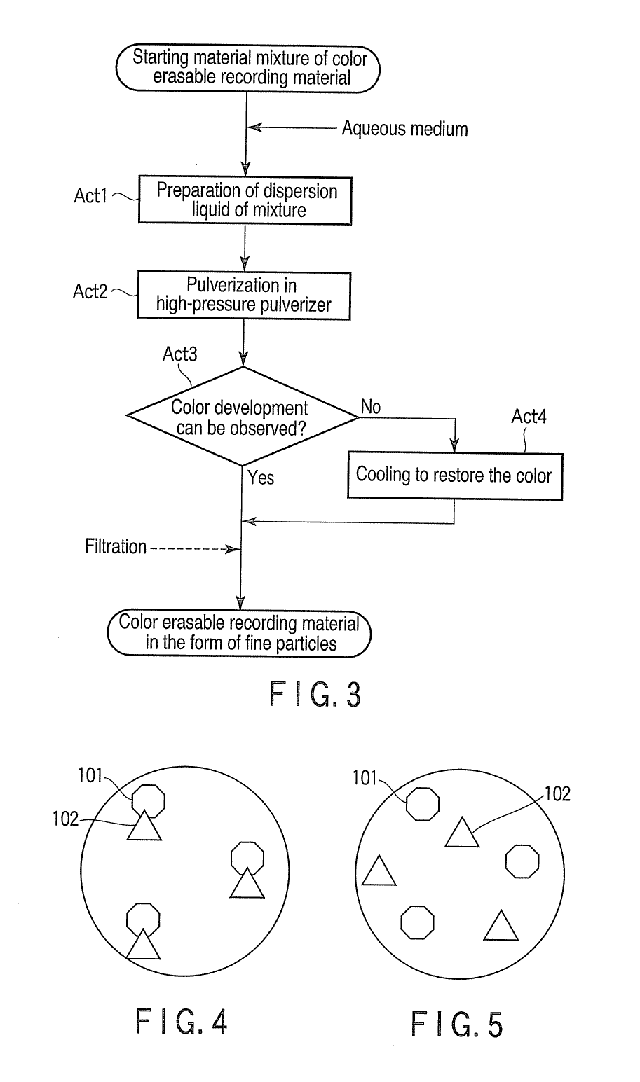

FIG. 3 is a flow diagram showing a modification example of the method shown in FIG. 1.

As shown in FIG. 3, this method is similar to the method shown in FIG. 1 except that after performing the pulverization step (Act 2), it is confirmed whether or not the color of the recording material fine particles is developed (Act 3), and if the color of the recording material fine particles turns out to be colorless or white, for example, the dispersion liquid is cooled to 20° C. or lower (Act 4) to allow the recording material fine particles to develop a color. The cooling temperature and the cooling time at this time vary depending on the kind of the color erasing agent, however, the cooling temperature can be set to a range from about −100° C. to +20° C. Moreover, it can be set to a range from −40° C. to +5° C. The cooling time also varies depending on the kind of the color erasing agent, however, it can be set to 1 to 24 hours.

By doing the above procedure, the color erasable recording material fine particles having a particle diameter of 1 μm or less can be obtained.

The color erasable recording material fine particles have a volume average particle diameter of from 0.05 to 1 μm. When the volume average particle diameter thereof is 0.05 μm or less, the developed color density is low. On the other hand, when the volume average particle diameter thereof is more than 1 μm, the following problems arise: in the case of a toner, it is difficult to incorporate the fine particles in the toner; and in the case of an ink, the particles precipitate or the nozzle is clogged.

As the color erasing agent having a melting point of from 40° C. to 200° C. to be used in one embodiment, a color erasing agent having a temperature hysteresis can be used. When the color is erased by heating at the time of melt-mixing or pulverization, by cooling to a color restoring temperature not higher than room temperature, the color can be restored. Further, the color erasing agent having a temperature hysteresis has an ability to rapidly erase the color and therefore is suitable for the use in a toner and an ink.

The surfactant to be used in the invention is preferably a surfactant other than alcohol-based and amine-based surfactants. Since alcohol-based and amine-based surfactants have a color erasing action, and therefore, there is a possibility that the color is erased at the time of pulverization and thereafter is not restored. Therefore, it is difficult to use nonionic and cationic surfactants, many of which are alcohol-based and amine-based surfactants. Accordingly, it is preferred to use an anionic surfactant.

With the use of the production method according to one embodiment, it becomes possible to produce color erasable recording material fine particles having a particle diameter of submicron order.

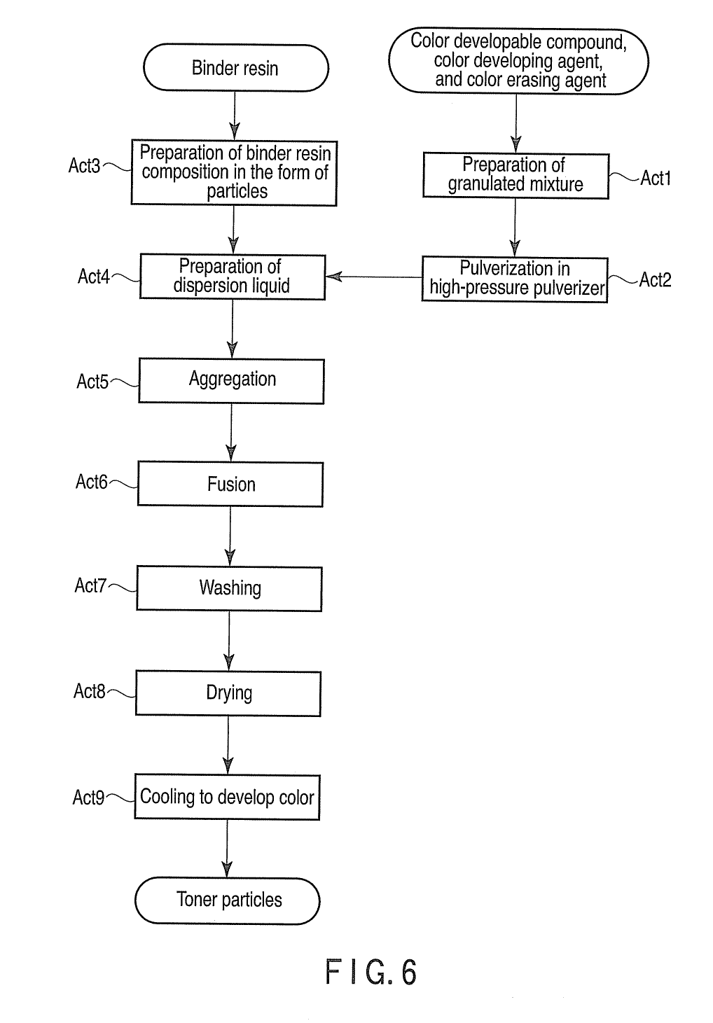

FIG. 6 is a flow diagram showing a method for producing a developing agent according to one embodiment.

First, in the same manner as the method shown in FIG. 1, a granulated mixture containing a starting material mixture of a color erasable recording material containing a color developable compound, a color developing agent, and a color erasing agent having a melting point of from 40° C. to 200° C. is prepared. Subsequently, coarsely pulverized particles are dispersed in an aqueous medium, whereby a dispersion liquid of coarsely pulverized particles is formed (Act 1). Subsequently, the resulting dispersion liquid is subjected to mechanical shearing using a high-pressure pulverizer to finely pulverize the coarsely pulverized mixture, whereby first fine particles containing color erasable recording material fine particles are formed (Act 2).

Separately, a binder resin material in the form of particles is prepared (Act 3).

The binder resin material as used herein means a binder resin alone or a composition containing a binder resin and an arbitrary addition component such as a release agent or a charge control agent.

For example, the granulated mixture of the binder resin material is dispersed in an aqueous medium, whereby an aqueous dispersion liquid is formed.

The granulated mixture is obtained by, for example, a step of melt-mixing a binder resin material and an arbitrary addition component such as a release agent or a charge control agent, and then, coarsely pulverizing the resulting mixture.

Subsequently, the dispersion liquid is subjected to a high-pressure pulverizer at a temperature not lower than the melting point of the binder resin material to pulverize the binder resin material particles in the dispersion liquid into fine particles having a particle diameter smaller than that of the binder resin material particles, whereby second fine particles containing a binder resin can be obtained.

Subsequently, a dispersion liquid containing the second fine particles containing at least a binder resin and the first fine particles containing a color developable compound, a color developing agent, and a color erasing agent is prepared (Act 4). Subsequently, the dispersion liquid containing the first and second fine particles is subjected to aggregation, whereby aggregated particles are formed (Act 5). Thereafter, for example, the aggregated particles are fused by heating (Act 6), the resulting fused particles are washed (Act 7), and the washed particles are dried by, for example, heating (Act 8), whereby toner particles can be formed. Further, in one embodiment, the dried particles can be cooled (Act 9) to a temperature enabling the restoration of the color of the recording material, which was erased by heating.

Onto surfaces of the toner particles, an additive of inorganic fine particles can be applied as needed.

The first fine particles have a volume average particle diameter of from 0.05 to 1 μm.

The second fine particles preferably have a volume average particle diameter of from 0.05 to 2 μm.

When the volume average particle diameter is less than the lower limit, the amount of an aggregating agent is increased and the chargeability or fixability tends to be deteriorated. Meanwhile, when the volume average particle diameter exceeds the upper limit, the particle diameter of the resulting toner is increased and the quality of an image tends to be deteriorated.

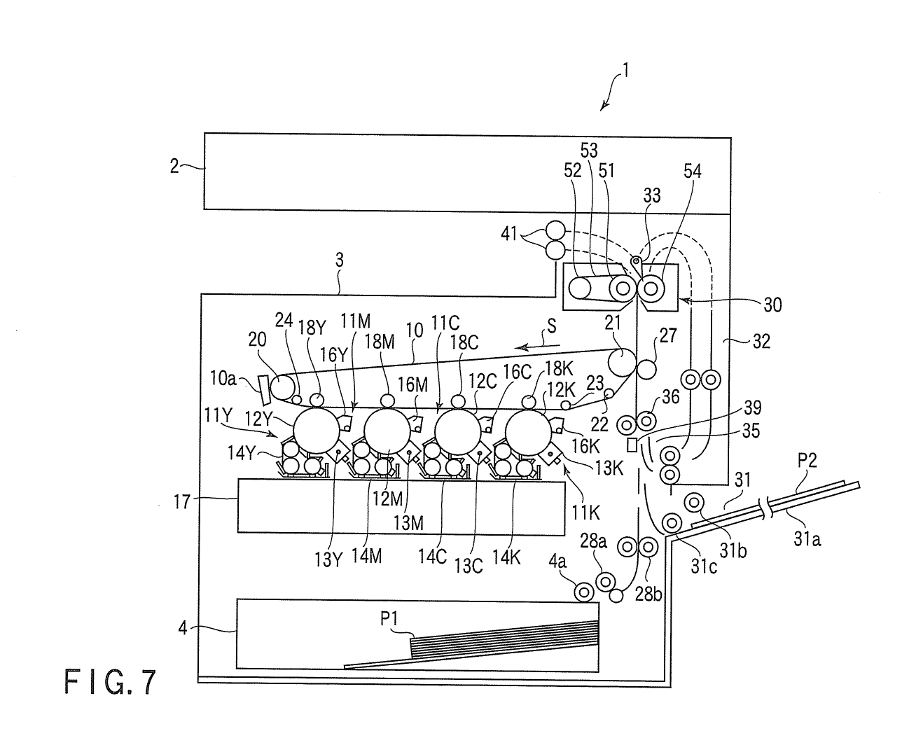

FIG. 7 is a schematic view showing a structure of a copier to which a developing agent obtained according to one embodiment can be applied.

As shown in FIG. 7, a four-drum tandem type color copier MFP (e-studio 4520c) 1 is provided with a scanner unit 2 and a paper discharge unit 3 in the upper part.

The color copier 1 has four sets of image forming stations 11Y, 11M, 11C, and 11K of yellow (Y), magenta (M), cyan (C), and black (K) arranged in parallel along the lower side of an intermediate transfer belt (intermediate transfer medium) 10.

The image forming stations 11Y, 11M, 11C, and 11K have photoconductive drums (image carrying members) 12Y, 12M, 12C, and 12K, respectively. Around the photoconductive drums 12Y, 12M, 12C, and 12K, electric chargers 13Y, 13M, 13C, and 13K, developing devices 14Y, 14M, 14C, and 14K, and photoconductor cleaning devices 16Y, 16M, 16C, and 16K are provided along the rotational direction of the arrow m, respectively. An exposure light from a laser exposure device (latent image forming device) 17 is applied to areas between the respective electric chargers 13Y, 13M, 13C, and 13K and the respective developing devices 14Y, 14M, 14C, and 14K around the photoconductive drums 12Y, 12M, 12C, and 12K, and electrostatic latent images are formed on the photoconductive drums 12Y, 12M, 12C, and 12K, respectively.

The developing devices 14Y, 14M, 14C, and 14K each have a two-component developing agent containing a toner of yellow (Y), magenta (M), cyan (C), or black (K) and a carrier and supply the toner to the electrostatic latent images on the photoconductive drums 12Y, 12M, 12C, and 12K, respectively.

The intermediate transfer belt 10 is tensioned by a backup roller 21, a driven roller 20, and first to third tension rollers 22 to 24. The intermediate transfer belt 10 faces and is in contact with the photoconductive drums 12Y, 12M, 12C, and 12K. At the positions of the intermediate transfer belt 10 facing the photoconductive drums 12Y, 12M, 12C, and 12K, primary transfer rollers 18Y, 18M, 18C, and 18K for primarily transferring toner images on the photoconductive drums 12Y, 12M, 12C, and 12K onto the intermediate transfer belt 10 are provided. The primary transfer rollers 18Y, 18M, 18C, and 18K are each a conductive roller, and apply a primary transfer bias voltage to the respective primary transfer parts.

In a secondary transfer part as a transfer position supported by the backup roller 21 of the intermediate transfer belt 10, a secondary transfer roller 27 is provided. In the secondary transfer part, the backup roller 21 is a conductive roller and a predetermined secondary transfer bias is applied thereto. When a sheet of paper (final transfer medium) which is a print target passes between the intermediate transfer belt 10 and the second transfer roller 27, the toner image on the intermediate transfer belt 10 is secondarily transferred onto the paper. After completion of the secondary transfer, the intermediate transfer belt 10 is cleaned by a belt cleaner 10a.

A paper feed cassette 4 for feeding a sheet of paper in the direction toward the secondary transfer roller 27 is provided below the laser exposure device 17. On the right side of the color copier 1, a manual feed mechanism 31 for manually feeding a sheet of paper is provided.

A pickup roller 4a, a separating roller 28a, a conveying roller 28b, and a resist roller pair 36 are provided between the paper feed cassette 4 and the secondary transfer roller 27, and these are constituent members of a paper feed mechanism. A manual feed pickup roller 31b and a manual feed separating roller 31c are provided between a manual feed tray 31a of the manual feed mechanism 31 and the resist roller pair 36.

Further, a medium sensor 39 for detecting the kind of a sheet of paper is disposed on a vertical conveying path 34 for conveying a sheet of paper in the direction from the paper feed cassette 4 or the manual feed tray 31a to the secondary transfer roller 27. In the color copier 1, the conveying speed of a sheet of paper, a transfer condition, a fixing condition, and the like can be controlled according to the detection result of the medium sensor 39. Further, a fixing device 30 is provided in the downstream of the secondary transfer part along the direction of the vertical conveying path 34.

The sheet of paper taken out from the paper feed cassette 4 or fed from the manual feed mechanism 31 is conveyed to the fixing device 30 along the vertical conveying path 34 through the resist roller pair 36 and the secondary transfer roller 27. The fixing device 30 has a set of a heating roller 51 and a driving roller 52, a fixing belt 53 wound around the heating roller 51 and the driving roller 52, and a facing roller 54 disposed to face the heating roller 51 via the fixing belt 53. The sheet of paper having the toner image transferred in the second transfer part is guided between the fixing belt 53 and the facing roller 54 and heated by the heating roller 51, whereby the toner image transferred onto the sheet of paper was fixed through the heat treatment. A gate 33 is provided in the downstream of the fixing device 30, and distributes the sheet of paper in the direction toward a paper discharge roller 41 or the direction toward a re-conveying unit 32. The sheet of paper guided to the paper discharge roller 41 is discharged to the paper discharge unit 3. Further, the sheet of paper guided to the re-conveying unit 32 is again guided in the direction toward the secondary transfer roller 27.

The image forming station 11Y integrally includes the photoconductive drum 12Y and a process system, and is provided such that it is attachable to and detachable from the image forming apparatus main body. The process system refers to at least one of the electric charger 13Y, the developing device 14Y, and the photoconductor cleaning device 16Y. The image forming stations 11M, 11C, and 11K each have the same structure as the image forming station 11Y, and each of the image forming stations 11Y, 11M, 11C, and 11K may be separately attachable to and detachable from the image forming apparatus, or they may be integrally attachable to and detachable from the image forming apparatus as an integral image forming unit 11.

Hereinafter, the color developable compound, the color developing agent, and the color erasing agent having a melting point of from 40° C. to 200° C. to be used as starting materials of the color erasable recording material will be described.

The color developable compound which can be used in embodiments is an electron donating compound which can be allowed to develop a color by the action of the color developing agent, and generally, a leuco dye can be exemplified. Examples of the leuco dye include diphenylmethane phthalides, phenylindolyl phthalides, indolyl phthalides, diphenylmethane azaphthalides, phenylindolyl azaphthalides, fluorans, styrynoquinolines, and diaza-Rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-(di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-i-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds, and bisquinazoline compounds. These compounds may be used in admixture of two or more kinds thereof.

The color-developing agent which can be used in embodiments is an electron accepting compound which donates a proton to a leuco dye. Examples thereof include phenols, metal salts of phenols, metal salts of carboxylic acids, aromatic carboxylic acids, aliphatic carboxylic acids having 2 to 5 carbon atoms, benzophenones, sulfonic acids, sulfonic acid salts, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole, and derivatives thereof. Additional examples thereof include those having, as a substituent, an alkyl group, an aryl group, an acyl group, an alkoxycarbonyl group, a carboxy group or an ester thereof, an amide group, a halogen group or the like, and bisphenols, trisphenols, phenol-aldehyde condensed resins, and metal salts thereof. These compounds may be used in admixture of two or more kinds thereof.

Specific examples thereof include phenol, o-cresol, tertiary butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid or esters thereof such as methyl 2,3-dihydroxybenzoate and methyl 3,5-dihydroxybenzoate, resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)-n-hexane, 1,1-bis(4-hydroxyphenyl)-n-heptane, 1,1-bis(4-hydroxyphenyl)-n-octane, 1,1-bis(4-hydroxyphenyl)-n-nonane, 1,1-bis(4-hydroxyphenyl)-n-decane, 1,1-bis(4-hydroxyphenyl)-n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)-n-heptane 2,2-bis(4-hydroxyphenyl)-n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol.

As the color erasing agent having a melting point of from 40° C. to 200° C. to be used in embodiments, a known substance can be used in a system of three components: a leuco dye, a color developing agent, and a color erasing agent as long as it is a substance which can change a color into colorless by inhibiting a color developing reaction between the leuco dye and the color developing agent through heating.

A model view showing a manner in which the color of fine particles of a color erasable recording material according to one embodiment is developed is shown in FIG. 4.

Further, a model view showing a manner in which the color of fine particles of a color erasable recording material according to one embodiment is erased is shown in FIG. 5.

As shown in FIGS. 4 and 5, it is considered that when a color developable compound 101 and a color developing agent 102 are non-uniformly dispersed or dissolved in the color erasing agent of the recording material, the color is developed, and when these two components are uniformly dispersed or dissolved in the color erasing agent, the color is erased.

In particular, a color developing and erasing mechanism utilizing the temperature hysteresis of a color erasing agent has an excellent instant color erasing property. This color erasing agent has a melting point and is used as a medium for the leuco dye and the color developing agent. When a mixture of these three components in a color-developed state is heated to a specific temperature Th or higher, the color can be erased. Further, even if the mixture in a color-erased state is cooled to Th or lower, the color-erased state is maintained. When the temperature of the mixture is further decreased, a color developing reaction between the leuco dye and the color developing agent is restored at a specific temperature Tc or lower to return to the color-developed state, whereby it is possible to cause a reversible color developing and erasing reaction. In particular, it is preferred that the color erasing agent to be used in the invention satisfies the relationship of the formula: Th>Tr>Tc, wherein Tr represents room temperature.

Examples of the color erasing agent which can exhibit such a temperature hysteresis include carboxylic acid esters containing a substituted aromatic ring, esters of a carboxylic acid containing an unsubstituted aromatic ring with an aliphatic alcohol, carboxylic acid esters containing a cyclohexyl group in the molecule, esters of a fatty acid with an unsubstituted aromatic alcohol or a phenol, esters of a fatty acid with a branched aliphatic alcohol, and esters of a dicarboxylic acid with an aromatic alcohol or a branched aliphatic alcohol.

Specific examples thereof include 4-benzyloxyphenylethyl butanoate, 4-benzyloxyphenylethyl pentanoate, 4-benzyloxyphenylethyl hexanoate, 4-benzyloxyphenylethyl heptanoate, 4-benzyloxyphenylethyl octanoate, 4-benzyloxyphenylethyl nonanoate, 4-benzyloxyphenylethyl decanoate, 4-benzyloxyphenylethyl undecanoate, 4-benzyloxyphenylethyl dodecanoate, 4-benzyloxyphenylethyl tridecanoate, 4-benzyloxyphenylethyl tetradecanoate, 4-benzyloxyphenylethyl pentadecanoate, 4-benzyloxyphenylethyl hexadecanoate, 4-benzyloxyphenylethyl heptadecanoate, 4-benzyloxyphenylethyl octadecanoate, 4-benzyloxyphenylethyl nonadecanoate, 4-benzyloxyphenylethyl eicosanoate, 4-benzyloxyphenylethyl tricosanoate, 4-benzyloxyphenylethyl tetracosanoate, 4-benzyloxyphenylethyl pentacosanoate, 4-benzyloxyphenylethyl hexacosanoate, 4-benzyloxyphenylethyl heptacosanoate, 4-benzyloxyphenylethyl octacosanoate, 4-benzyloxyphenylethyl nonacosanoate, 4-benzyloxyphenylethyl triacontanoate, 4-benzyloxyphenylethyl hentriacontanoate, benzyl cinnamate, heptyl stearate, didecyl adipate, dilauryl adipate, dimyristyl adipate, dicetyl adipate, distearyl adipate, trilaurin, trimyristin, tristearin, dimyristin, and distearin. These compounds may be used in admixture of two or more kinds thereof.

On the other hand, a compound which does not have a wide temperature hysteresis as described above can also be used as the color erasing agent. In this case, the color-erased state cannot be maintained at room temperature, however, while the compound is being heated to a temperature not lower than the melting point thereof, the color can be erased.

Specific examples of such a compound include oxides of an aliphatic hydrocarbon wax such as an oxidized polyethylene wax and block copolymers thereof; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; and waxes containing a fatty acid ester as a main component such as montanic acid ester wax and castor wax; and materials obtained by deoxidization of a part or the whole of a fatty acid ester such as deoxidized carnauba wax. Further, saturated linear fatty acids such as palmitic acid, stearic acid, montanic acid, and a long chain alkyl carboxylic acid having a long chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and a long chain alkyl alcohol having a long chain alkyl group; polyhydric alcohols such as sorbitol; fatty acid amides such as linoleic acid amide, oleic acid amide, and lauric acid amide; saturated fatty acid bisamides such as methylenebis stearic acid amide, ethylenebis caprylic acid amide, ethylenebis lauric acid amide, and hexamethylenebis stearic acid amide; unsaturated fatty acid amides such as ethylenebis oleic acid amide, hexamethylenebis oleic acid amide, N,N′-dioleyladipic acid amide, and N,N′-dioleylsebaccic acid amide; aromatic bisamides such as m-xylenebisstearic acid amide and N,N′-distearylisophthalic acid amide; waxes obtained by grafting of a vinyl monomer such as styrene or acrylic acid on an aliphatic hydrocarbon wax; partially esterified products of a fatty acid and a polyhydric alcohol such as behenic acid monoglyceride; and methyl ester compounds having a hydroxyl group obtained by hydrogenation of a vegetable fat or oil can be exemplified.

The mixing ratio of the color developable compound, the color developing agent, and the color erasing agent varies depending on the density, the color changing temperature, and the kinds of the respective components, however, when the amount of the leuco dye is taken as 1, the ratio of the color developing agent is from 0.1 to 100, preferably from 0.1 to 50, and more preferably from 0.5 to 20; and the ratio of the color erasing agent is from 1 to 800, preferably from 5 to 200, and more preferably from 5 to 100.

As a production device which can be used in embodiments, for example, the following devices can be used.

A mixer is not particularly limited as long as it can perform melt-mixing, however examples thereof include a single-screw extruder, a twin-screw extruder, a pressure kneader, a Banbury mixer, and a Brabender mixer.

Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by the Japan Steel Works, Ltd.), TEM (manufactured by Toshiba Machine Co., Ltd.), ZSK (manufactured by Warner K.K.), and KNEADEX (manufactured by Mitsui Mining Co., Ltd.).

A grinder is not particularly limited as long as it can grind materials in a dry state, and examples thereof include a ball mill, an atomizer, a Bantam mill, a pulverizer, a hammer mill, a roll crusher, a cutter mill, and a jet mill.

A pulverizer is not particularly limited as long as it can pulverize materials in a wet state, and examples thereof include high-pressure pulverizers such as Nanomizer (manufactured by Yoshida Kikai Co., Ltd.), Altimizer (manufactured by Sugino Machine, Ltd.), NANO 3000 (manufactured by Beryu Co., Ltd.), Microfluidizer (manufactured by Mizuho Industrial Co., Ltd.), and Homogenizer (manufactured by Izumi Food Machinery Co., Ltd.); rotor stator stirrers such as Ultra Turrax (manufactured by IKA Japan K.K.), T.K. Auto Homo Mixer (manufactured by Primix Corporation), T.K. Pipeline Homo Mixer (manufactured by Primix Corporation), T.K. Filmics (manufactured by Primix Corporation), Clear mix (manufactured by M-Technique Co., Ltd.), Clear SS5 (manufactured by M-Technique Co., Ltd.), Cavitron (manufactured by Eurotec, Ltd.), and Fine Flow Mill (manufactured by Pacific Machinery & Engineering Co., Ltd.); and medium-type stirrers such as Visco mill (manufactured by Aimex Co., Ltd.), Apex mill (manufactured by Kotobuki Industries Co., Ltd.), Star Mill (manufactured by Ashizawa Finetech, Ltd.), DCP Super flow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.). Such a pulverizer can also be used when toner component particles and an aggregating agent are mixed.

As the surfactant which can be used in embodiments, an anionic surfactant, a cationic surfactant, an amphoteric surfactant, a nonionic surfactant, or the like can be used. However, from the viewpoint of the color erasing action, an anionic surfactant is preferred. Examples of the anionic surfactant include fatty acid salts, alkyl sulfate ester salts, polyoxyethylene alkyl ether sulfate ester salts, alkyl benzene sulfonate salts, alkyl napthalene sulfonate salts, dialkyl sulfosuccinate salts, alkyl diphenyl ether disulfonate salts, polyoxyehtylene alkyl ether phosphate salts, alkenyl succinate salts, alkane sulfonate salts, napthalene sulfonic acid formalin condensate salts, aromatic sulfonic acid formalin condensate salts, polycarboxylic acids, and polycarboxylate salts.

As a dispersion aid, a pH adjusting agent can be used.

As the pH adjusting agent, an acid such as hydrochloric acid, sulfuric acid, nitric acid, acetic acid, citric acid, or phosphoric acid; or an alkali such as sodium hydroxide, potassium hydroxide, ammonia, or an amine compound can be used. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane. A surfactant that exhibits acidity or alkalinity can also be used as the pH adjusting agent.

Hereinafter, embodiments will be specifically described by showing Examples.

### EXAMPLE 1

### Composition of Starting Material Mixture of Color Erasable Recording Material

Hereinafter, unless otherwise specified, the term “part” refers to “part by weight”.

Color developable compound: 3,3-bis(p-dimethylaminophenyl)-6-dimethylaminophthalide: 5 parts

Color developing agent: bisphenol A: 10 parts

Color erasing agent: trilaurin (melting point: 45° C.): 35 parts

A mixture of the above composition was mixed by heating to 200° C., and the resulting mixture in a white semi-solid state was cooled in a refrigerator to develop a color. Then, the mixture was pulverized using a mixer, whereby a molten powder mixture which developed a blue color was obtained.

### Composition of Dispersion Liquid

The above molten mixture: 50 parts

Anionic surfactant: 1% aqueous solution of sodium dodecylbenzene sulfonate: 500 parts

The components of the above composition were mixed and heated to 60° C., and the mixture was dispersed using a homogenizer T25 (manufactured by IKA Japan K.K.), whereby a dispersion liquid was prepared. The volume average particle diameter of the particles in the dispersion liquid was 12 μm.

Subsequently, a pulverization treatment at 150 MPa and 80° C. was performed using a high-pressure pulverizer NANO 3000 (manufactured by Beryu Co., Ltd.). The NANO 3000 used is provided with a hopper as a starting material feed unit, a high-pressure pipe for heat exchange having a length of 12 m immersed in an oil bath as a heating unit, a high-pressure pipe having nozzles with a diameter of 0.13 μm or 0.28 μm arranged in a row therein as a pressure applying unit, a medium-pressure pipe having cells with a pore diameter of 0.4 μm, 1.0 μm, 0.75 μm, 1.5 μm, or 1.0 μm arranged in a row therein as a pressure reducing unit, and a heat exchange pipe having a length of 12 m capable of cooling with tap water as a cooling unit. The white dispersion liquid obtained after the treatment was cooled in a refrigerator to develop a color. Here, the confirmation as to whether or not the color of the color erasable recording material was developed was performed as follows. A sample was cooled in a refrigerator at about 5° C. for 1 to 8 hours, and a state of color development was checked every hour. The case where there was no change even the sample was cooled for 8 hours was determined that the color was not developed. Thereafter, the dispersion liquid was left as such at normal temperature, and then subjected to suction filtration through a filter paper, GC-90 (manufactured by Advantec Toyo Kaisha, Ltd.), whereby a dispersion liquid of the color erasable recording material fine particles which developed a blue color was obtained. The thus obtained fine particles have a volume average particle diameter of 0.3 μm.

### Color Erasure Experiment

A small amount of the resulting dispersion liquid of the color erasable recording material fine particles which developed a blue color was allowed to penetrate into a sheet of paper and then dried by leaving it as such at normal temperature, whereby an image which developed a blue color was obtained. Then, when the image was heated to 60° C. on a hot plate, the color was completely erased, and the color-erased state was maintained even after the temperature was returned to normal temperature.

### EXAMPLE 2

### Composition of Starting Material Mixture of Color Erasable Recording Material

Color developable compound: 3,3-bis(p-dimethylaminophenyl)-6-dimethylaminophthalide: 5 parts

Color developing agent: bisphenol A: 10 parts

Color erasing agent: rice wax (melting point: 75° C.): 35 parts

A mixture of the above composition was mixed by heating to 200° C., the resulting mixture was cooled and then pulverized using a mixer, whereby a molten powder mixture which developed a blue color was obtained.

### Composition of Dispersion Liquid

The above molten mixture: 50 parts

Anionic surfactant: 1% aqueous solution of sodium dodecylbenzene sulfonate: 500 parts

The components of the above composition were mixed and heated to 95° C., and the mixture was dispersed using a homogenizer T25 (manufactured by IKA Japan K.K.), whereby a dispersion liquid was prepared. The volume average particle diameter of the particles in the dispersion liquid was 18 μm.

Subsequently, a pulverization treatment at 150 MPa and 100° C. was performed using a high-pressure pulverizer NANO 3000 (manufactured by Beryu Co., Ltd.) provided with the same units as in Example 1. The white dispersion liquid obtained after the treatment was cooled in a refrigerator to develop a color. Thereafter, the dispersion liquid was left as such at normal temperature, and then subjected to suction filtration through a filter paper, GC-90 (manufactured by Advantec Toyo Kaisha, Ltd.), whereby a dispersion liquid of the color erasable recording material fine particles which developed a blue color was obtained. The thus obtained fine particles have a volume average particle diameter of 0.1 μm.

### Color Erasure Experiment

A small amount of the resulting dispersion liquid of the color erasable recording material fine particles which developed a blue color was allowed to penetrate into a sheet of paper and then dried by leaving it as such at normal temperature, whereby an image which developed a blue color was obtained. Then, when the image was heated to 80° C. on a hot plate, the color was completely erased. However, when the temperature was returned to normal temperature, the blue color was developed again.

### EXAMPLE 3

### Composition of Starting Material Mixture of Color Erasable Recording Material

Color developable compound: 3,3-bis(p-dimethylaminophenyl)-6-dimethylaminophthalide: 5 parts

Color developing agent: bisphenol A: 10 parts

Color erasing agent: trilaurin (melting point: 45° C.): 35 parts

A mixture of the above composition was mixed by heating to 200° C., the resulting mixture in a white semi-solid state was cooled in a refrigerator to develop a color, and then, the mixture was pulverized using a mixer, whereby a molten powder mixture which developed a blue color was obtained.

### Composition of Dispersion Liquid

The above molten mixture: 50 parts

Anionic surfactant: 1% aqueous solution of sodium dodecylbenzene sulfonate: 500 parts

The components of the above composition were mixed and heated to 60° C., and the mixture was dispersed using a homogenizer T25 (manufactured by IKA Japan K.K.), whereby a dispersion liquid was prepared. The volume average particle diameter of the particles in the dispersion liquid was 12 μm.

Subsequently, a pulverization treatment at 150 MPa and 80° C. was performed using a high-pressure pulverizer NANO 3000 (manufactured by Beryu Co., Ltd.) provided with the same units as in Example 1. The white dispersion liquid obtained after the treatment was cooled in a refrigerator to develop a color. Thereafter, the dispersion liquid was left as such at normal temperature, whereby a dispersion liquid of the color erasable recording material fine particles which developed a blue color was obtained. The thus obtained fine particles which developed a color have a volume average particle diameter of 0.6 μm.

### Color Erasure Experiment

A small amount of the resulting dispersion liquid of the color erasable recording material fine particles which developed a blue color was allowed to penetrate into a sheet of paper and then dried by leaving it as such at normal temperature, whereby an image which developed a blue color was obtained. Then, when the image was heated to 60° C. on a hot plate, the color was completely erased, and the color-erased state was maintained even after the temperature was returned to normal temperature.

### EXAMPLE 4

### Preparation of Toner

### Composition of Binder Resin Material

Polyester resin (glass transition temperature: 45° C., softening point: 100° C.) as a binder resin: 94 parts

Rice wax as a release agent: 5 parts

TN-105 (manufactured by Hodogaya Chemical Co., Ltd.) as a charge control agent: 1 part

A binder resin material of the above composition was mixed to homogeneity using a dry mixer, and the resulting mixture was melt-kneaded at 80° C. using PCM-45 (manufactured by Ikegai Iron Works Ltd.) which is a twin-screw kneader. The resulting toner composition was pulverized to 2 mm mesh pass using a pin mill, and further pulverized to an average particle diameter of 50 μm using a Bantam mill.

### Composition of Dispersion Liquid

Binder resin material particles: 30 parts

Sodium dodecylbenzene sulfonate as a surfactant: 0.9 parts

Dimethyl aminoethanol as a pH adjusting agent: 0.45 parts

Ion exchanged water: 68.65 parts

Subsequently, the components of the above composition were mixed, followed by vacuum defoaming, whereby a dispersion liquid was obtained.

Subsequently, the dispersion liquid was subjected to a pulverization treatment at 180° C. and 150 MPa using NANO 3000 (manufactured by Beryu Co., Ltd.) provided with the same units as in Example 1, and then, the pressure was reduced while maintaining the temperature at 180° C. Thereafter, the dispersion liquid was cooled to 30° C., whereby a dispersion liquid containing binder resin material fine particles was obtained. The average particle diameter of the particles in the thus obtained dispersion liquid was measured using SALD-7000 (manufactured by Shimadzu Corporation) and found to be 0.5 μm.

### Preparation of Toner Material Dispersion Liquid

1.7 parts of the dispersion liquid of the color erasable recording material fine particles of Example 1, 15 parts of the above dispersion liquid of the binder resin material particles, and 83 parts of ion exchanged water were mixed, and 5 parts of a 5% aqueous solution of aluminum sulfate was added thereto while stirring the mixture at 6500 rpm using a homogenizer (IKA Japan K.K.). Then, the temperature was raised to 40° C. while stirring the mixture at 800 rpm in a 1 L stirring vessel equipped with a paddle blade. After the mixture was left as such at 40° C. for 1 hour, 10 parts of a 10% aqueous solution of sodium polycarboxylate was added thereto to effect aggregation. Then, the resulting mixture was heated to a temperature not lower than the glass transition point of the binder resin (in this case, 68° C.) to effect fusion, and left as such for 1 hour. Then, the mixture was cooled, whereby a colorless toner material dispersion liquid was obtained.

Subsequently, this toner dispersion liquid was washed by repeating a procedure including filtration and washing with ion exchanged water until the electrical conductivity of the filtrate became 50 μS/cm. Thereafter, the washed toner dispersion liquid was dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby a color erasable toner was obtained. The particle diameter of the thus obtained toner was measured using Multisizer 3 (manufactured by Beckman Coulter, Inc.) and it was found that the 50% volume average particle diameter Dv was 6.5 μm. The thus obtained toner particles were cooled in a refrigerator, whereby a toner which developed a blue color was obtained.

The thus obtained toner was mixed with a ferrite carrier coated with a silicone resin, and an image was output using MFP (e-studio 4520c) manufactured by Toshiba Tec Corporation from which a fixing device was removed and heated to 80° C. on a hot plate, whereby a color-undeveloped fixed image was obtained. The thus obtained image was placed in a refrigerator for 1 hour, whereby a color-developed image was obtained.

It was confirmed that when the thus obtained color-developed image was placed in a fixing device which was set to a temperature of 100° C., the image turned into colorless.

### EXAMPLE 5

### Preparation of Ink

### Composition of Ink

Dispersion liquid of color erasable recording material fine particles of Example 1: 80 parts

10% sodium dodecylbenzene sulfonate: 5 parts

Glycerin as an anti-drying agent: 15 parts

The components of the above composition were mixed, and the resulting mixture was filtered through a filter paper having a pore size of 5 μm, whereby an inkjet ink was prepared.

The thus obtained ink was applied to Pulse Injector (manufactured by Cluster Technology Co., Ltd.), and an ejection test was performed. As a result, it was confirmed that the ink could be ejected. The nozzle diameter of the inkjet head is 25 μm. It was confirmed that when the resulting color-developed image was heated to 60° C., the image turned into colorless.

### COMPARATIVE EXAMPLE 1

### Composition of Starting Material Mixture of Color Erasable Recording Material

Color developable compound: 3,3-bis(p-dimethylaminophenyl)-6-dimethylaminophthalide: 5 parts

Color developing agent: bisphenol A: 10 parts

Color erasing agent: trilaurin (melting point: 45° C.): 35 parts

A mixture of the above composition was mixed by heating to 200° C., and the resulting mixture in a white semi-solid state was cooled in a refrigerator to develop a color. Then, the mixture was pulverized using a mixer, whereby a molten powder mixture which developed a blue color was obtained.

### Composition of Dispersion Liquid

The above molten mixture: 50 parts

Anionic surfactant: 1% aqueous solution of sodium dodecylbenzene sulfonate: 500 parts

The components of the above composition were mixed and heated to 60° C., and the mixture was dispersed using a homogenizer T25 (manufactured by IKA Japan K.K.), whereby a dispersion liquid was prepared. The volume average particle diameter of the particles in the dispersion liquid was 12 μm.

### Preparation of Toner Material Dispersion Liquid

1.7 parts of the dispersion liquid of the color erasable recording material particles of Comparative Example 1, 15 parts of the dispersion liquid of the binder resin material particles of Example 4, and 83 parts of ion exchanged water were mixed, and 5 parts of a 5% aqueous solution of aluminum sulfate was added thereto while stirring the mixture at 6500 rpm using a homogenizer (IKA Japan K.K.). Then, the temperature was raised to 40° C. while stirring the mixture at 800 rpm in a 1 L stirring vessel equipped with a paddle blade. After the mixture was left as such at 40° C. for 1 hour, 10 parts of a 10% aqueous solution of sodium polycarboxylate was added thereto to effect aggregation. Then, the resulting mixture was heated to a temperature not lower than the glass transition point of the binder resin (in this case, 68° C.) to effect fusion, and left as such for 1 hour. Then, the mixture was cooled, whereby a colorless toner material dispersion liquid was obtained. The particle diameter of the thus obtained toner was measured using Multisizer 3 (manufactured by Beckman Coulter, Inc.) and it was found that the 50% volume average particle diameter Dv was 25 μm, and the resulting toner had an extremely large particle diameter.

### Preparation of Ink

### Composition of Ink

Dispersion liquid of color erasable recording material fine particles of Comparative Example 1 (particle diameter: 12 μm): 80 parts

10% sodium dodecylbenzene sulfonate: 5 parts

Glycerin as an anti-drying agent: 15 parts

The components of the above composition were mixed, whereby an inkjet ink was prepared.

The thus obtained ink was applied to Pulse Injector (manufactured by Cluster Technology Co., Ltd.), and an ejection test was performed. As a result, the clogging of the inkjet head nozzle occurred and printing could not be performed. The nozzle diameter of the inkjet head is 25 μm.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for producing a color erasable recording material, comprising:
dispersing a granulated mixture containing a color developable compound, a color developing agent, and a color erasing agent having a melting point of from 40° C. to 200° C. in an aqueous medium to form an aqueous dispersion liquid of the granulated mixture; and
subjecting the dispersion liquid to a high-pressure pulverizer at a temperature not lower than the melting point of the color erasing agent to pulverize the granulated mixture in the dispersion liquid to obtain a particulate color erasable recording material having a volume average particle diameter smaller than the particle diameter of the granulated mixture.

2. The method according to claim 1, wherein the color erasable recording material has a volume average particle diameter of from 0.05 to 1 μm.

3. The method according to claim 1, wherein the color erasing agent has a temperature hysteresis.

4. The method according to claim 1, wherein the aqueous medium further contains an anionic surfactant.

5. The method according to claim 1, further comprising cooling the dispersion liquid containing a particulate color erasable recording material to 20° C. or lower to allow the particulate color erasable recording material to develop a color.

6. A color erasable recording material, comprising fine particles obtained by dispersing a granulated mixture containing a color developable compound, a color developing agent, and a color erasing agent having a melting point of from 40° C. to 200° C. in an aqueous medium to form an aqueous dispersion liquid of the granulated mixture and subjecting the dispersion liquid to a high-pressure pulverizer at a temperature not lower than the melting point of the color erasing agent to pulverize the granulated mixture in the dispersion liquid into fine particles having a particle diameter smaller than that of the granulated mixture.

7. The material according to claim 6, which has a volume average particle diameter of from 0.05 to 1 μm.

8. A method for producing a color erasable developing agent, comprising:
dispersing a granulated mixture containing a color developable compound, a color developing agent, and a color erasing agent having a melting point of from 40° C. to 200° C. in an aqueous medium, thereby forming an aqueous dispersion liquid of the granulated mixture;
subjecting the dispersion liquid to a high-pressure pulverizer at a temperature not lower than the melting point of the color erasing agent to pulverize the granulated mixture in the dispersion liquid, thereby obtaining a color erasable recording material in the form of fine particles having a volume average particle diameter smaller than the particle diameter of the granulated mixture;
preparing an aqueous dispersion liquid containing the color erasable recording material in the form of fine particles, a binder resin material in the form of particles, and an aqueous medium; and
aggregating the recording material in the form of fine particles and the binder resin material in the form of particles in the dispersion liquid, thereby obtaining toner particles.

9. The method according to claim 8, wherein the color erasable recording material has a volume average particle diameter of from 0.05 to 1 μm.

10. The method according to claim 8, wherein the color erasing agent has a temperature hysteresis.

11. The method according to claim 8, wherein the aqueous medium further contains an anionic surfactant.

12. The method according to claim 8, further comprising cooling the dispersion liquid containing the particulate color erasable recording material to 20° C. or lower, to allow the particulate color erasable recording material to develop a color.

13. The method according to claim 8, wherein the binder resin material in the form of particles is obtained by dispersing binder resin material particles in an aqueous medium to form an aqueous dispersion liquid, and subjecting the dispersion liquid to the high-pressure pulverizer at a temperature not lower than the melting point of the binder resin material to pulverize the binder resin material particles in the dispersion liquid into fine particles having a particle diameter smaller than that of the binder resin material particles.

14. The method according to claim 13, wherein the binder resin material in the form of particles has a volume average particle diameter of from 0.05 to 2 μm.

15. A color erasable developing agent, comprising toner particles obtained by preparing an aqueous dispersion liquid containing a binder resin material in the form of particles, an aqueous medium, and a particulate color erasable recording material obtained by dispersing a granulated mixture containing a color developable compound, a color developing agent, and a color erasing agent having a melting point of from 40° C. to 200° C. in an aqueous medium to form an aqueous dispersion liquid of the granulated mixture, subjecting the dispersion liquid to a high-pressure pulverizer at a temperature not lower than the melting point of the color erasing agent to pulverize the granulated mixture in the dispersion liquid into a particulate color erasable recording material having a particle diameter smaller than that of the granulated mixture; and aggregating the recording material in the form of fine particles and the binder resin material in the form of particles in the dispersion liquid.

16. The developing agent according to claim 15, wherein the color erasable recording material has a volume average particle diameter of from 0.05 to 1 μm.

17. The developing agent according to claim 15, wherein the binder resin material in the form of particles has a volume average particle diameter of from 0.05 to 2 μm.
